(19) United States
(12) Patent Application Publication
(10) Pub. No.: US 2004/0133301 A1
(43) Pub. Date: Jul. 8, 2004

(54) Process and apparatus for improving and controlling the vulcanization of natural and synthetic rubber compounds

(75) Inventors: John C. Van Doren, Bailey, CO (US); Richard Magill, Broomfield, CO (US); Bruce Sellers, Golden, CO (US); Tim Erickson, Littleton, CO (US); Scott Schneider, Littleton, CO (US); Steve Courington, Lone Tree, CO (US); Lance Bethel, Westminster, CO (US)

Correspondence Address: SHERIDAN ROSS PC, 1560 BROADWAY, SUITE 1200, DENVER, CO, 80202

(73) Assignee: Signature Control Systems, Denver, CO

(21) Appl. No.: 10/666,433

(22) Filed: Sep. 18, 2003

Related U.S. Application Data
(63) Continuation-in-part of application No. 10/267,197, filed on Oct. 8, 2002.
(60) Provisional application No. 60/394,736, filed on Jul. 9, 2002.

(51) Int. Cl. B29C 39/00

(52) U.S. Cl. 700/199

(57) ABSTRACT

A process for curing a natural or synthetic rubber includes the measuring of curing conditions by dielectric or impedance means to produce a process curve (impedance property data versus time) followed by analyzing the process curve with a software algorithm which defines and statistically quantifies the correlation between the process curve and the desired part properties. The correlation relationship is applied in real time to end the curing process at the optimum time and to produce rubber parts of uniform quality and with reduced process cycle time.

### RELATED APPLICATIONS

This is a Continuation-in-Part application of pending prior application Ser. No. 10/267,197 filed Oct. 8, 2002, which claims the benefit of U.S. Provisional Patent Application Serial No. 60/394,736 filed Jul. 9, 2002. The present application also claims benefit of U.S. patent application Ser. No. 09/815,342 filed Mar. 21, 2001. The entire disclosure of these prior applications are considered to be part of the disclosure of this accompanying application and are hereby incorporated by reference.

### RELATED FIELD OF THE INVENTION

This invention relates to a new and improved process and apparatus for monitoring and controlling the vulcanization of natural and synthetic rubber compounds containing fillers such as carbon black, oils, clay, and the like. Typical base rubber polymers which may be employed include styrene-butadiene, polybutadiene, polyisoprene, ethylene-propylene, butyl, halobutyl, nitrile, polyacrylic, neoprene, hypalon, silicone, fluorcarbon elastomers, polyurethane elastomers, and mixtures thereof.

### BACKGROUND OF THE INVENTION

Heretofore methods of applying fixed process parameters to the processing of polymeric rubber compounds during vulcanization have resulted in both reduced productivity due to overly conservative cure times and poor product uniformity due to the inability of the fixed process parameters to accommodate the inherent variability in the process.

The relationship of dielectric properties and the state and rate of the cure of polymers is well known. Related publications, included herein fully by reference, in this field are:

### U.S. PATENT DOCUMENTS

| | | |
|---|---|---|
| 4,344,142 | 8/1982 | Diehr, II et al. |
| 4,373,092 | 2/1983 | Zsolnay |
| 4,399,100 | 8/1983 | Zsolnay, et al. |
| 4,423,371 | 12/1983 | Senturia, et al. |
| 4,496,697 | 1/1985 | Zsolnay, et al. |
| 4,510,103 | 4/1985 | Yamaguchi, et al. |
| 4,551,807 | 11/1985 | Hinrichs, et al. |
| 4,723,908 | 2/1988 | Kranbuehl |
| 4,777,431 | 10/1988 | Day, et al. |
| 4,773,021 | 9/1988 | Harris, et al. |
| 4,868,769 | 9/1989 | Persson, et al. |
| 5,032,525 | 7/1991 | Lee, et al. |
| 5,219,498 | 6/1993 | Keller, et al. |
| 5,317,252 | 5/1994 | Kranbuehl |
| 5,486,319 | 1/1996 | Stone, et al. |
| 5,528,155 | 6/1996 | King, et al. |
| 5,872,447 | 2/1999 | Hager, III |

### OTHER PUBLICATIONS

Changes in the Electrical Properties of Natural Rubber/Carbon Black Compounds during Vulcanization, 1957, H. Desanges, French Rubber Institute

A novel method of measuring cure—dielectric vulcametry, 1986, Sture Persson, The Plastics and Rubber Institute, England

A comparative study of step curing and continuous curing methods, 1994, D. Khastgir, Indian Institute of Technology

AC Impedance Spectroscopy of Carbon Black-Rubber composites, 1999, K. Rajeshwar, University of Texas at Arlington

The prior art has clearly established a relationship between the dielectric (herein also referred to as “impedance”) properties of polymeric resins. For example these resins, exhibit rheometric and chemical behavior such as melt, volatile release, gelation, and crosslinking that can be recognized by dielectric means for those skilled both in the art and those resins' physical properties. However, unlike polymeric resins, polymeric rubber compounds do not melt or exhibit gelation during cure or vulcanization and are therefore much more difficult to characterize, monitor and control by dielectric means. Moreover, none of the prior art associated with polymeric rubber curing (also referred to as “vulcanization”) addresses the practical aspects of taking measurements directly in the production process, especially in the highly abrasive and high pressure environment of injection molding. Additionally the prior art does not show how to use the electrical data obtained to achieve closed-loop control of the curing or vulcanization process over a wide range of molding methods and conditions.

The prior art also does not show how to compensate in the vulcanization process: (a) for variations in compound from batch to batch and within batches, and (b) for differences in vulcanizate thickness. Additionally, the prior art does not compensate for additional variables, which are introduced into the process by the nature of the vulcanization equipment, tooling, and thermal history of the compound.

Moreover, the prior art uses dielectric or impedance measuring apparatus, which employ opposing and parallel electrodes of precise area and separation distance, and in which, the electrodes are in direct contact with the rubber compound. Although such electrodes and apparatus provide a means for measuring impedance properties during cure, they are entirely impractical for use in a production environment. For example, many rubber components are produced using injection molding technology which subjects the sensors to pressures up to 30,000 psi and temperatures up to 425° F. Moreover, due to the flow inside the mold during injection, in addition to the carbon and silica fillers present in many rubber compounds, the sensor must survive in a highly abrasive environment. Finally, the sensor must also be able to survive mold cleaning via typical cleaning methods such as CO₂ and plastic bead blast.

Accordingly, it is desirable to have an apparatus and method for alleviating the above described drawbacks to using impedance data measurements for monitoring and controlling the vulcanization process. In this case, the impedance sensor provided at the vulcanization equipment is both extremely rugged and more easily used in that the electrodes: (a) need not be of precise area, (b) need not be of precise separation distance from one another, and (c) need not be in direct contact with the material being vulcanized. In addition, it would be desirable to have a method for correlating the desired properties of the rubber product with the impedance measurements.

Definitions and Terms

Numerous technical terms and abbreviations are used in the description below. Accordingly, many of these terms and abbreviations are described in this section for convenience. Thus, if a term is unfamiliar to the reader, it is suggested that this section be consulted to obtain a description of the unknown term.

Rubber Polymeric Compounds: Typical base rubber polymeric compounds which may be employed with the method and apparatus of the present invention include styrene-butadiene, polybutadiene, polyisoprene, ethylene-propylene, butyl, halobutyl, nitrile, polyacrylic, neoprene, hypalon, silicone, fluorcarbon elastomers, polyurethane elastomers, and mixtures thereof.

ODR: Oscillating Disk Rheometer—A device that measures the rheological characteristics (elastic torque, viscous torque, etc.) of a polymer during vulcanization, using an oscillating disk to apply stress to the curing polymer.

MDR: Moving Die Rheometer—A device that measures the rheological characteristics (elastic torque, viscous torque, etc.) of a polymer during vulcanization, using a moving die to apply stress to the curing polymer.

Rheometric instrument: A device that measures the rheological characteristics (elastic torque, viscous torque, etc.) of a polymer during vulcanization.

T90 Time: The time, as measured in an ODR or MDR at which a given rubber compound at a given curing temperature, reaches 90% of its ultimate elastic torque value.

Designed Experiment. A single set of actual related experiments drawn up from one of the types of designs to be found in the body of methods for design of experiments.

Exponential Dampening: The damping coefficient (α) as defined by a best exponential fit to a set of raw data, where the fit curve (y) is described by the equation:

y=Ae^{-αt}, where t is time.

Exponential Amplitude Coefficient: The amplitude coefficient (A) as defined by a best exponential fit to a set of raw data, where the fit curve (y) is described by the equation

y=Ae^{-αt}, where t is time.

Topological Features of Impedance Related Data: Recognizable and distinct features within a cure curve, such as a peak (maxima), valley (minima) or flat (no slope).

Low CTE Metallic Material: A material with a low coefficient of thermal expansion.

Tool Steel. A steel suitable for use in making injection and compression molds such as AISI Type A2 Tool Steel.

Witness cavity: A small cavity for in-mold vulcanization measurement. whereby the dielectric sensor does not directly sense any of the parts that are being produced. Instead, the sensor monitors the cure in the “witness” location.

R-square (R²): R-square (also known as the coefficient of determination) is a statistical measure of the reduction in the total variation of the dependent variable due to the independent variables. An R-square close to 1.0 indicates that the model (also referred to herein, as the “algorithm”) accounts for almost all of the variability in the respective variables.

Confidence interval: A range of values within which a particular number of interest is calculated to fall, at some specific level of probability such as 95%.

### SUMMARY OF THE INVENTION

The present invention is a method and system for controlling the vulcanization (herein also denoted “curing”) of rubber polymeric compounds. In particular, the present invention includes novel features for monitoring the polymerization and determining in real-time the optimum cure time for the production of parts made from rubber polymeric compounds (herein also denoted as merely “rubber compounds”). According to the present invention, during the curing of rubber polymeric compounds distinctive impedance property versus time graphs (herein such graphs are also denoted “process curves”) may be obtained from one or more capacitor circuits operatively configured so that such a rubber polymeric compound for curing becomes part of each such capacitor circuit, and in particular, becomes a dielectric for such circuits. More specifically, the present invention utilizes, e.g., shape and/or curve characteristics of the impedance (Z), phase angle (ø), resistance (R), reactance (X), conductance (G), or capacitance (C) versus time graphs derived from the signal responses output by the activation of one or more of these capacitor circuits, wherein such activation is the result of at least one, and more generally, a plurality of different signals being input to such capacitor circuits. Thus, in some embodiments of the present invention, the shape (or other computational characteristics) of a corresponding process curve for each of a plurality of different signal frequencies input to the capacitor circuits may be used in monitoring, controlling and/or predicting an outcome of a curing process.

In some embodiments of the present invention, various time series capacitor circuit output data components (i.e., impedance (Z), phase angle (ø), resistance (R), reactance (X), conductance (G), or capacitance (C)) are separately processed, thereby resulting in a process curve with distinctive shape (or other features) for each of these components. Accordingly, it is an aspect of the present invention that such features from impedance (Z), phase angle (ø), resistance (R), reactance (X), conductance (G), or capacitance (C) graphs (e.g., plotted versus time) can be used for monitoring and controlling the cure time by measuring a portion of the process curve and calculating or predicting the optimum cure time. Thus, since a particular shape (or other computational feature) of such process curves may be substantially repeatable for curing a particular material, such features can be effectively utilized in a mass production environment for producing consistent high quality cured products (e.g., seals, gaskets, and tires).

Moreover, it is a further aspect of the present invention that for a given polymeric rubber material to be cured, the invention can identify at least some of the computational features of these process curves substantially independently of the configuration of the product being produced via the use of a “witness cavity” incorporated into the runner system which channels the rubber from the injection point to the part cavities of the mold, as one skilled in the art will understand. In particular, such computational features can be correlated with the chemical and rheometric changes occurring during the curing process.

Thus, although such process curves may vary in amplitude and duration (e.g., due to cured part thickness, thermal history, mold temperature and heat rate, curative level, compound batch variations, and various other factors), the present invention may be used for monitoring, controlling and/or predicting cure states of products in a mass production environment wherein the products being produced may be subject to significant process and rubber compound variation.

For example, for a particular sample or product to be cured, properties of one or more of the above described process curves can be calculated for a specific measurement period wherein a portion of the data corresponding to the process curve of the sample may be correlated to a desired final cure state of the product. Thus, such a correlation can be used to establish a time for appropriately curing a part in production wherein the part is substantially identical to the sample. In particular, the present invention predicts cure times as will be described more fully herein below.

It is a further aspect of the present invention, that in various embodiments and for certain rubber compounds, the corresponding shape of one or more of the above described process curves may exhibit a “maxima” and/or a “minima” at a given time which can also be used to infer useful information in monitoring, controlling and/or predicting the cure time.

It is a further aspect of the present invention that embodiments thereof include signal processing and other software and hardware (“components”) for both deriving such computational features of the process curves obtained from a rubber compound being cured, and utilizing such features to determine in real-time the optimum cure time for each production cure cycle.

Moreover, it is an aspect of the present invention that such cure times are determined to achieve a desired property such as tensile strength, dynamic stiffness, or compression set in the resulting cured part.

Additional aspects, features and benefits of the present invention will become evident from the accompanying drawings and the detailed description herein below.

### BRIEF DESCRIPTION OF THE FIGURES

FIG. 1 Shows the sensor arrangement schematically in a mold.

FIG. 2 Shows an exploded view of one embodiment of the sensor.

FIG. 3 Shows the sensor electrical circuit.

FIG. 4 Shows sensor capacitance data collected at 8 frequencies from 3 kHz to 10 kHz.

FIG. 5 Shows sensor conductance data collected at 8 frequencies from 3 kHz to 10 kHz.

FIG. 6 Shows the correlation between observed T90 times and an impedance measurement.

FIG. 7 Shows the correlation between observed T90 times and 4-term multiple regression of impedance measurements.

FIG. 8 Shows a plot of modifier setting versus a specific part property (compression set).

FIG. 9 Shows the Control Algorithm development logic.

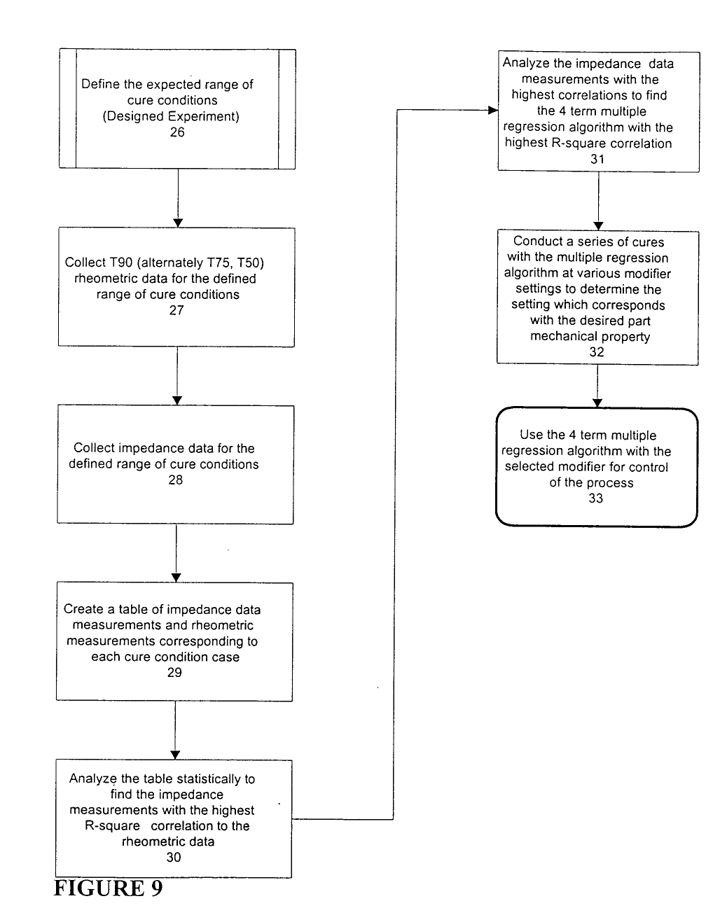

FIG. 10 Shows the Control System schematic.

FIG. 11 Shows the Control System logic.

FIG. 12 Shows another embodiment of the present invention.

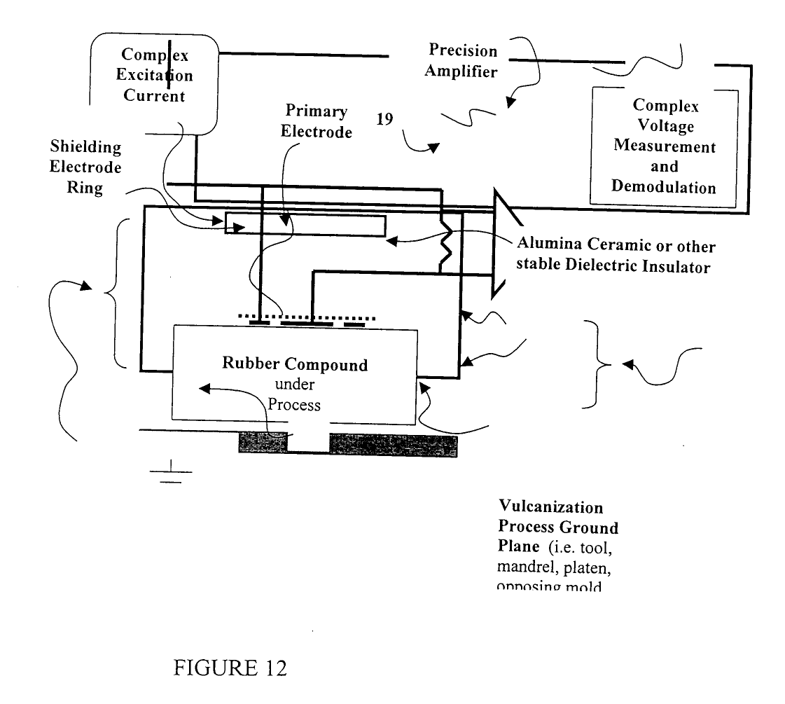

### DESCRIPTION OF THE PREFERRED EMBODIMENTS

A representative embodiment of the invention can fundamentally be broken into five key components, which together form the equipment and tools necessary for use of the impedance property monitoring in injection and other rubber molding environments such as compression molding, transfer molding, and the like. These components are identified as follows:

(2.1) Production-capable sensor

(2.2) Sensor circuit (non-bridged)

(2.3) Demodulation methodology for the sensor signal

(2.4) Methodology for establishing control algorithms

(2.5) Real-time control application

Each of these components (2.1) through (2.5) are described hereinbelow.

(2.1) Production-Capable Sensor

The prior art uses dielectric or impedance measuring apparatuses that employ opposing and parallel electrodes of precise area and separation distance. Additionally, the metallic electrodes are typically in direct contact with the rubber compound. Although such electrodes and apparatus provide a means for measuring impedance properties during cure, they are entirely impractical for use in a production environment. For example, many rubber components are produced using injection-molding technology that subjects the sensors to pressures up to 30,000 psi and temperatures up to 425° F. Moreover, due to the flow inside the molds during injection, and the carbon and silica fillers present in many rubber compounds, the sensor must survive in a highly abrasive environment. Finally, the sensor must be able to survive mold cleaning via the use of CO₂ bead blast, plastic bead blast, and the like.

Accordingly, it is desirable to have a sensor for alleviating the above described drawbacks to using in-situ impedance data for monitoring and controlling the vulcanization process, wherein the impedance sensor provided at the vulcanization equipment is both extremely rugged and more easily used in that the electrodes need not be of precise area, need not be of precise separation distance from one another, and need not be in direct contact with the material being vulcanized.

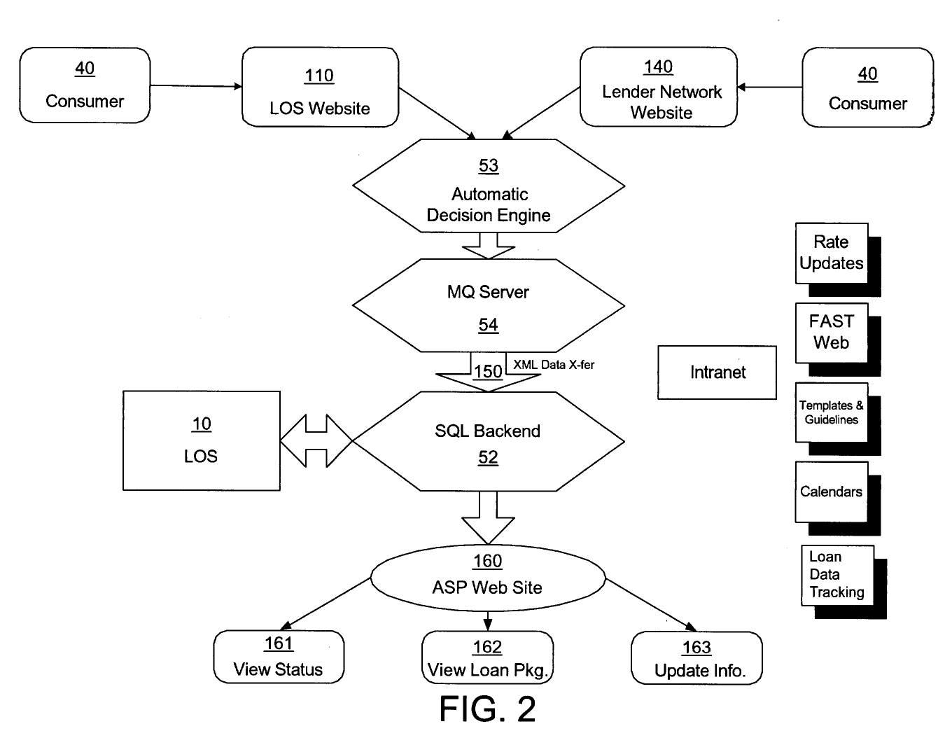

The impedance sensor 17 that satisfies the above requirements includes a primary electrode 10 that serves as a capacitor plate. An additional capacitor, acting as a guard or shielding electrode 11, rings the primary electrode of each such sensor 17 (there may be more than one of these sensors). The guard electrode 11, which is excited along with the electrode 10 helps to preclude the field induced at the primary electrode 10 of the sensor from fringing or becoming non-linear. Both electrodes may be a low CTE metallic material, such as Kovar, embedded in a layered ceramic circuit using methods developed by Lamina Ceramics of Princeton, N.J. An alternative embodiment of the sensor 17 (shown in FIG. 2), wherein this embodiment includes a nested construction of A2 tool steel components consisting of a sensor housing 12, primary electrode 10, and guard electrode 11 that are separated radially by a cyanate ester potting material and axially by a thin ceramic coating such as alumina ceramic or other stable dielectric insulating material. The alumina ceramic coating is applied with a thermal spray process (i.e. detonation gun, plasma, or HVOF spray process, as is well known by those skilled in the art) that provides electrical isolation and transmits the compressive loads generated by the process. In addition, the electrode and guard are separated from the rubber compound being cured by a dielectrically stable material such as a thin coating of alumina ceramic 13 or like material applied with a detonation gun or other high velocity ceramic spray process, wherein the material is dielectrically stable over the temperature range of the vulcanizing process (e.g., 300° F. to 425° F.). A coaxial cable is connected to the sensor via an MCX connector such as Johnson Components' MCX connector 14, p.n. 133-833-401 which is screwed into the guard. The center conductor mates with a pin machined integral with or press fit into the electrode. In another embodiment of the sensor described in FIG. 2, the primary electrode 10, guard electrode 11, and housing 12, along with an alumina ceramic face may be fused together and separated electrically with glass or glass doped with alumina ceramic. In another embodiment of the sensor described in FIG. 2, the primary electrode 10, guard electrode 11, and housing 12 may be coated with a diamond or diamond-like 2-4 micron coating such as Casidium as supplied by Anatech Ltd of Springfield, Va. and then press fit together such that the diamond or diamond-like coating provides electrical isolation between the three elements and between the rubber compound and the face of the sensor.

Therefore the production-ready sensor 17 may be an extremely rugged device, capable of survival in a high pressure, high abrasion, and high temperature environment. The fundamental electrical function of the sensor 17 is to act as a guarded or shielded electrode, forming a single plate of a capacitor.

Any other planar or semi-planar conductive surface within the interior of the vulcanizing equipment (typically the mold 18) can serve as the opposing electrode plate of the capacitor. Note that the opposing plate acts as the third electrode of the capacitor, and thus the opposing plate electrically couples with the primary electrode. Further note that the opposing plate is electrically grounded 25 to provide a common signal reference point.

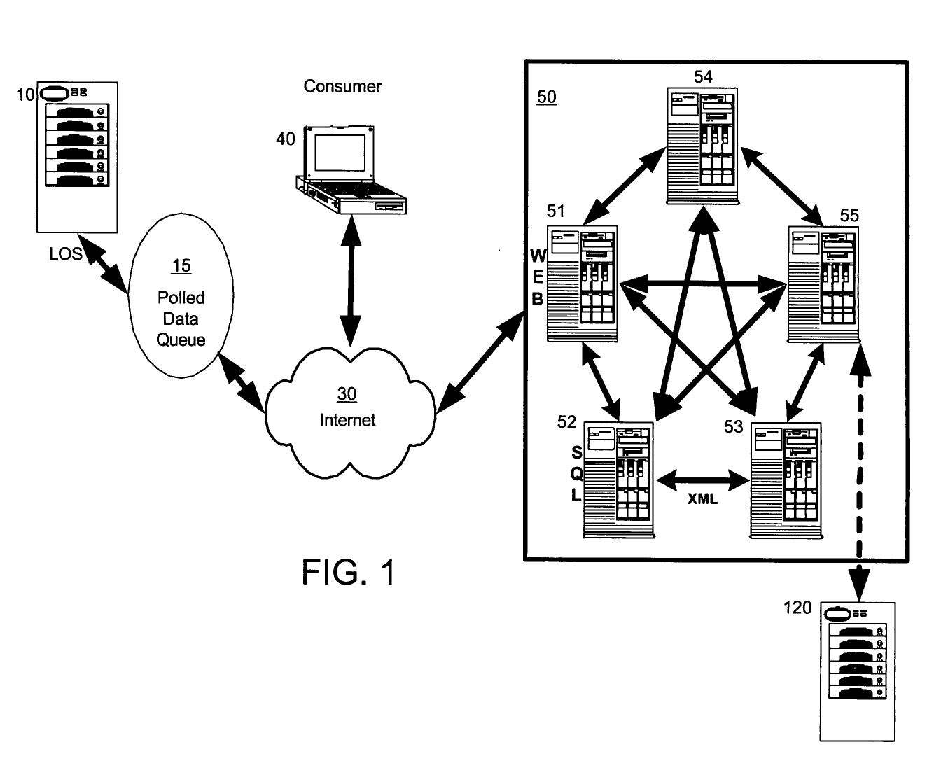

The vulcanizing rubber compound 16 in the injection mold 18 then becomes the dielectric within the formed capacitor, as it is sandwiched between the sensor 17 and the surface of the mold 18 or metallic insert within the part being molded (the opposing electrode). Since the dielectric properties of the rubber change as the rubber vulcanizes, the impedance of the formed capacitor changes as well, which allows for a non-invasive method of monitoring and controlling vulcanization in the mold 18. FIG. 1 shows the most detailed view of sensor 17 provided in the mold 18.

The sensor 17 may be flush mounted in the mold 18 in contact with the rubber compound 16 in the part cavity being molded or located in contact with the rubber compound 16 in the runner system feeding the part cavity, or alternately may be located in contact with the rubber compound 16 injected into a “witness cavity” adjacent to the runner system. Such witness cavities may be particularly important in applications, where the parts being produced are too small or the dimensional specifications are too strict to allow sensor placement directly on the part. Since this rubber is from the same batch, sees the same mold temperature, and experiences the same heat history, it provides a good representation of curing behavior observed in the part itself. In addition, more than one sensor can be used to monitor the process, and the lagging sensor from cycle to cycle can be used to control the end point of any given cure cycle.

(2.2) Sensor Circuit (Non-Bridged)

Electrical circuits described in the prior art typically include the use of bridge circuits, which are often complex and poorly suited for automation, in that the bridge circuits typically require an operator to manually balance the bridge.

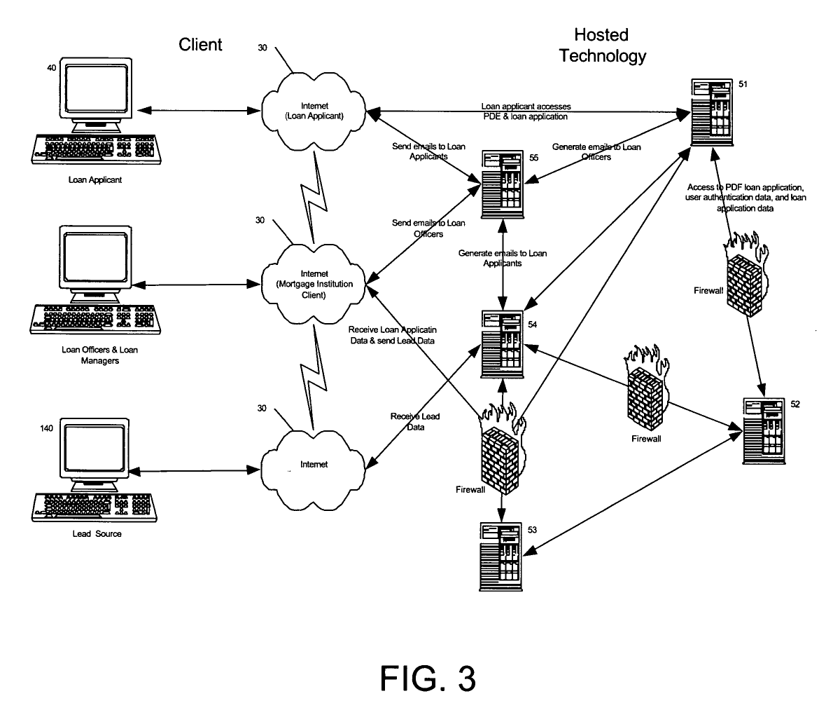

The sensor circuit (FIG. 3) for the present invention includes only a simple RC voltage divider as shown in FIG. 3, wherein the current is driven to an electrically grounded 25 mold 18 (the opposing capacitor plate) through the curing rubber compound 23. A load resistor 19 (typically 200 k-ohm) is placed in line with the flow of current, and the resultant output voltage 20, V2 across the resistor 19 is measured with a high precision amplifier. By simultaneously measuring the applied voltage 21 (also known as the excitation voltage), it is then possible to readily determine the amount of attenuation and phase shift resultant from the flow of complex current. FIG. 3 illustrates the sensor electrical circuit, where the applied (excitation) voltage 21, V0=sin ωt, is placed at one terminal of the amplifier, and this potential drives a complex current I* through the load resistor 19 (R) and then finally through the capacitor formed by the sensor 24, rubber compound 23, and the electrically grounded 25 mold 18.

The following description assumes a voltage amplitude of 1 volt for the excitation voltage 21 V0. However, all the subsequent analysis remains the same if the voltage is not unity; in the non-unity cases, k becomes the ratio of the negative pin voltage and the positive pin voltage.

From the illustration above, the excitation voltage 21 (V0=sin ωt) drives a complex current (I*) through the resistor 19, R to ground 25. V0 is a digitally generated sine wave, generated by a high-speed data acquisition card, such as the PCI-MIO-16E4 card manufactured by National Instruments of Austin, Tex., that produces high quality sinusoidal signals at frequencies varying from 10 Hz to 10 kHz (as specified by the user); however, other data acquisition cards 35 available from National Instruments are also within the scope of the invention which would extend the frequency range to 200 kHz. A voltage drop occurs across the load resistor 19, leaving an attenuated and phase shifted signal at the negative pin 22, V1=k sin(ωt+θ)=k<θ, where < is used to denote the term “at a phase angle of.” The rubber compound 23 between the sensor 24 and electrically grounded 25 mold 18 provides a complex impedance of magnitude Z at phase angle Φ.

(2.3) Demodulation of the Sensor Signal.

Calculating Z and Φ is done by simultaneously digitally capturing the excitation signal V0 (sin(ωt)) and the amplifier output voltage V2 20, where V2=sin(ωt)−k sin(ωt+θ). The previously referenced high-speed data acquisition card is used to digitize the signals V0 21 and V2 20, preserving the digital representation of the waveforms for further digital signal processing.

Provided with the digitally preserved signals V0 21 and V2 20, measurement of the quantities k and θ is done via standard demodulation practices, as is understood by one skilled in the art.

Once the quantities k and θ have been measured, determination of Z and Φ is done by analyzing the circuit described in FIG. 3.

i. I*=(V0−V1)/R

ii. Z=V1/I*

iii. Substituting, since V1=k<θ and V0=1

iv. Impedance (Z)=R*(k<θ)/(1−k<θ)=Z<Φ

v. As can be seen in the equation above, the magnitude Z and phase angle are easily derived from the knowns, R, k, and θ.

vi. Converting the polar number into a complex number separates out the real and imaginary components, resistance and reactance.

vii. Reactance (X)=Z sin Φ=1/wC, where w=2πf

viii. Resistance (R)=Z cos Φ

ix. Converting these quantities into conductance and capacitance is accomplished by inverting the equations of vii and viii:

x. Capacitance (C)=1/(w*Z sin Φ)

xi. Conductance (G)=I/Z cos Φ

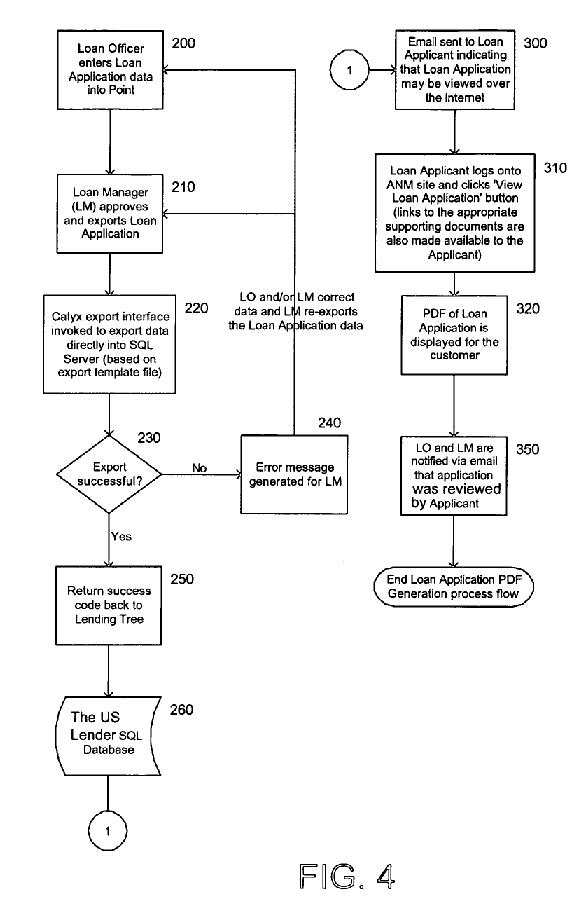

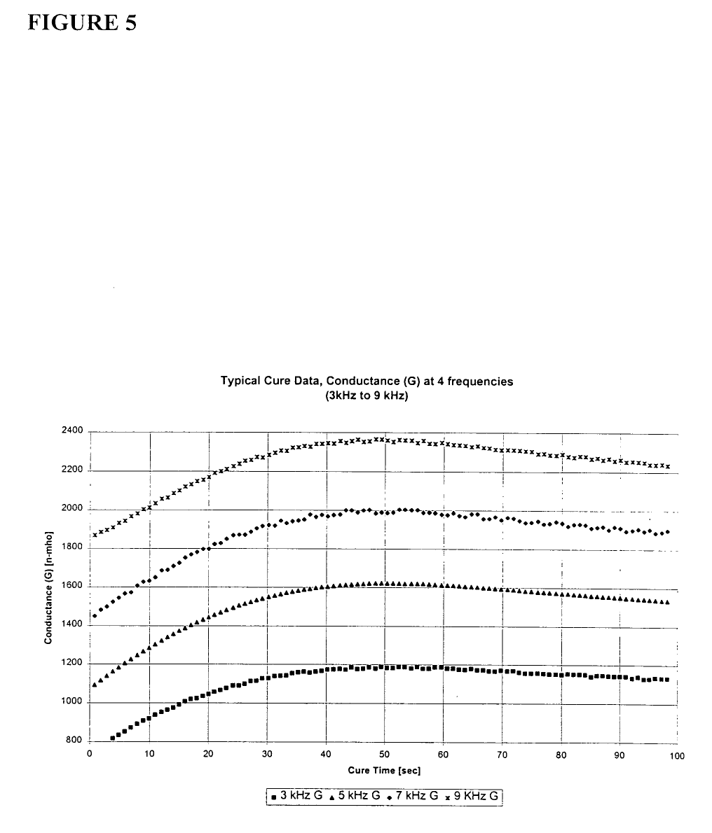

Any of the data pairs (Z and Φ, R and X, G and C) can then be used to represent the resultant cure data (also referred to as “process curves”). FIG. 4 shows a typical set of capacitance (C) data collected from a rubber compound cure process according to the present invention, wherein the data collected is displayed at 4 different excitation frequencies from 3 kHz to 9 kHz. FIG. 5 shows a typical set of conductance (G) data collected from the same rubber compound cure, wherein the data collected is again displayed at 4 different excitation frequencies from 3 kHz to 9 kHz.

(2.4) Methodology for Establishing Control Algorithms

Given that impedance property data (Z and Φ, R and X, and/or G and C) is observed and recorded during a cure, as depicted in FIGS. 4 and 5, the next step is to establish a control method that is capable of:

(a) measuring such impedance property data directly in the production process, and

(b) reaching a conclusion with respect to proper cure time for a particular production cycle, based on such data measurement.

The process for algorithm development is outlined below:

(2.4.1) Embodiment for Algorithm Development Using a Production Mold and a Rheometer:

(Step 26) As part of the algorithm development, define a range of cure conditions or a statistically designed experiment that: (i) includes the range of variation expected to occur within normal production curing processes, and that (ii) would also result in a range of proper or expected cure times.

For example, variation expected to occur within the normal curing production process may include: (i) a batch change which may have a different curing characteristics, requiring a different cure time to reach optimal cure state or (ii) a +/−10 degree F. change in mold temperature could also be expected, which would necessitate a different cure time to reach the same cure state.

The following TABLE A is illustrative of a typical defined range of cure conditions this would include a variety of batches, processed over a range of temperatures, as described below:

TABLE A

| Case number | Mold temperature | Batch number |
|---|---|---|
| 01 | 5 F. below nominal | Batch A |
| 02 | 5 F. below nominal | Batch B |
| 03 | 5 F. below nominal | Batch C |
| 04 | nominal | Batch A |
| 05 | nominal | Batch B |
| 06 | nominal | Batch C |
| 07 | 5 F. above nominal | Batch A |
| 08 | 5 F. above nominal | Batch B |
| 09 | 5 F. above nominal | Batch C |

(Step 27) Now that a range of potential conditions has been defined, it is also possible to rheometrically determine an optimal cure time and/or a relative rate of cure for each of the conditions. A typical optimal cure time target might be the T90 time, the time that the curing rubber reaches 90% of its final elastic torque maximum, although other cure state times are also appropriate targets (e.g. T50, T75, etc.), as one skilled in the art will understand. So for each of the cure conditions described in the table above, it is possible to set a rheometer to the specified temperature, enter a sample of the specified batch, and measure the proper T90 time 27. An example of the type of data observed is as follows in TABLE B:

TABLE B

| | | | Proper Cure |
|---|---|---|---|
| Case | | Batch | time (T90: |
| number | Mold temperature | number | seconds) |
| 01 | 5 F. below nominal | Batch A | 120 |
| 02 | 5 F. below nominal | Batch B | 135 |
| 03 | 5 F. below nominal | Batch C | 142 |
| 04 | nominal | Batch A | 100 |
| 05 | nominal | Batch B | 110 |
| 06 | nominal | Batch C | 115 |
| 07 | 5 F. above nominal | Batch A | 90 |
| 08 | 5 F. above nominal | Batch B | 95 |
| 09 | 5 F. above nominal | Batch C | 98 |

Fundamentally, the purpose of the rheometry is to establish the relative cure rates under various conditions. Since in-mold conditions will vary significantly from rheometric instrument conditions, the optimum production cure time may not be the same as the T90 time from the rheometer. However, the rheometric data does provide useful information regarding the relative cure rates and times observed due to rubber compound batch and cure temperature variations.

(Step 28) Now that information (e.g. TABLE B above) exists regarding the effects of the cure process variation on proper cure time as measured by rheometric means, the present step is to create those same conditions in the production mold, and to observe the resultant impedance property data during those cures. Multiple replicates of the cure conditions are ideal—at least three replicates are recommended. Therefore, for example, the production mold is set at a temperature 5 degrees below nominal, and batch A is used as the rubber compound. Three cures are conducted while recording the impedance data, which appears in the form similar to FIGS. 4 and 5. Then the compound is changed to batch B and three more cures are recorded, etc. When complete, the impedance data files will be associated with each cure condition as described in TABLE C below:

TABLE C

| | | | Proper | |
|---|---|---|---|---|
| | | | Cure time | Associated |
| Case | | Batch | (T90: | impedance |
| number | Mold temperature | number | seconds) | files |
| 01 | 5 F. below nominal | Batch A | 120 | 01, 02, 03 |
| 02 | 5 F. below nominal | Batch B | 135 | 04, 05, 06 |
| 03 | 5 F. below nominal | Batch C | 142 | 07, 08, 09 |
| 04 | nominal | Batch A | 100 | 10, 11, 12 |
| 05 | nominal | Batch B | 110 | 13, 14, 15 |
| 06 | nominal | Batch C | 115 | 16, 17, 18 |
| 07 | 5 F. above nominal | Batch A | 90 | 19, 20, 21 |
| 08 | 5 F. above nominal | Batch B | 95 | 22, 23, 24 |
| 09 | 5 F. above nominal | Batch C | 98 | 25, 26, 27 |

(Step 29) Given that these conditions have been set in both the rheometer and in the mold, the present step involves searching for a statistical correlation between the rheometrically-determined T90 times and the impedance data. In other words, the impedance data must be searched for measures that reflect the cure state. In order to mathematically determine the correlation, it is necessary to measure the impedance data in some fashion. Measurements are performed as follows:

a. Each data stream (a data stream is a Z, Φ, R, X, G or C plot versus time at a specific frequency) is divided into 5 or more specific time segments or “windows”. Using software written in LabView, available from National Instruments, Austin, Tex., the segment start time, stop time, and length can be automatically generated using preset values or custom-specified by the user using the software.

b. For each segment selected measurements are obtained in the following eight ways:

i. The maximum value is recorded

ii. The time of the maximum value is recorded.

iii. The minimum value is recorded.

iv. The time of the minimum value is recorded.

v. The integrated area under the segment is recorded.

vi. A linear least-squares best fit is done to the segment data, and the slope of the line is recorded. [m, in the equation y=mx+b].

vii. An exponential best fit is done to the segment data, and the damping coefficient is recorded. [α, in the equation y=Ae^{-αx}].

viii. An exponential best fit is done to the segment data, and the amplitude coefficient is recorded. [A, in the equation y=Ae^{αx}].

After obtaining these measurements a data table is created. (as illustrated in TABLE D below) Note that only a portion of the possible number of cases is shown—a total of 640 impedance measurements are typically made on each file: 8 frequencies times 2 data types (R and X, G and C, or Z and Φ) times 5 window times 8 measurement types=640 measurements.

TABLE D

| | | | | Window 1, | Window 1, | Window 1, |
|---|---|---|---|---|---|---|
| File | Mold | Batch | Proper Cure time | data stream 1, | data stream 1, | data stream 1, |
| number | temperature | number | (T90: seconds) | slope | max | time of max |
| 01 | 5 F. below | Batch A | 120 | .117 | 10.13 | 48 |
| | nominal | | | | | |
| 02 | 5 F. below | Batch A | 120 | .114 | 10.21 | 48 |
| | nominal | | | | | |
| 03 | 5 F. below | Batch A | 120 | .112 | 10.24 | 49 |
| | nominal | | | | | |
| 04 | 5 F. below | Batch B | 135 | .105 | 10.25 | 51 |
| | nominal | | | | | |
| 05 | 5 F. below | Batch B | 135 | .105 | 10.13 | 51 |
| | nominal | | | | | |
| 06 | 5 F. below | Batch B | 135 | .108 | 10.18 | 51 |
| | nominal | | | | | |
| 07 | 5 F. below | Batch C | 142 | .099 | 10.33 | 53 |
| | nominal | | | | | |
| 08 | 5 F. above | Batch C | 142 | .098 | 10.09 | 52 |
| | nominal | | | | | |
| 09 | 5 F. above | Batch C | 142 | .101 | 10.20 | 53 |
| | nominal | | | | | |
| 10 | nominal | Batch A | 100 | .156 | 10.33 | 39 |
| Etc. | | | | | | |

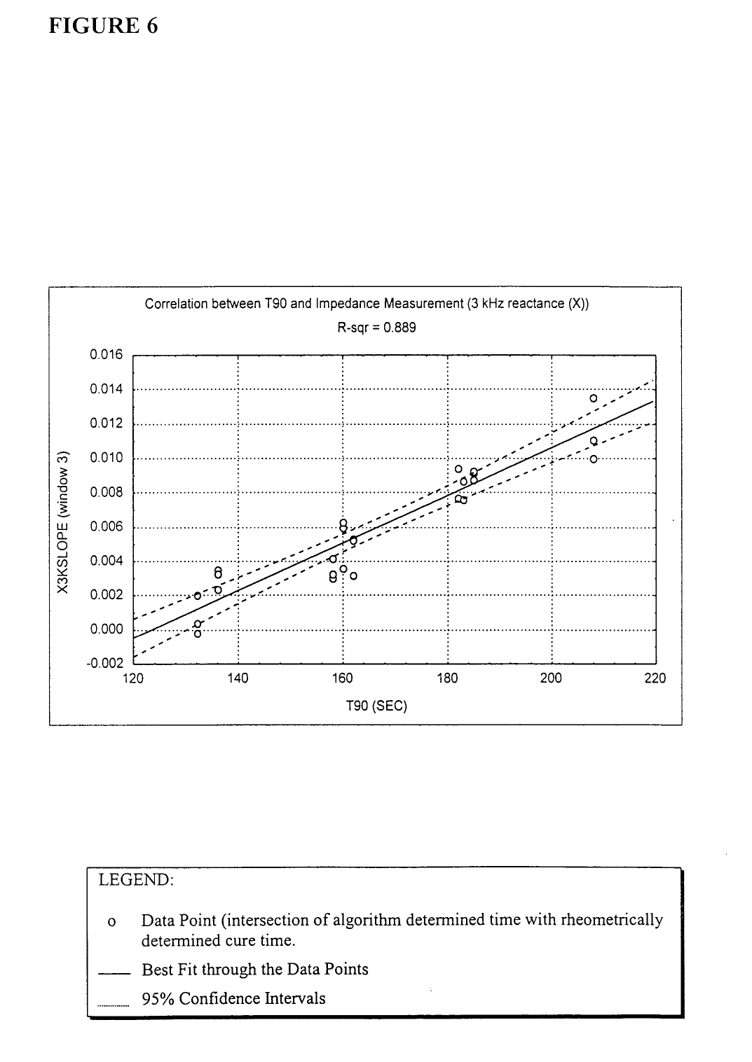

(Step 30) Given that there are now a large number of “cached” measurements, it is then possible to search through all the measurements to find a measure that appears to most strongly reflect the rate of cure. This is done by finding the measures made in Step 29 with the highest correlation to the rheometry measurements made in Step 27. Software, written in LabView, available from National Instruments, Austin, Tex., systematically performs a correlation between the T90 data (Step 27) and the in-mold measurements (Step 29), and then ranks and returns the measurements that are most reflective of cure rate. FIG. 6 shows a typical correlation between observed T90 times and an impedance measurement.

It has been determined that not only do the above correlations help identify the measures that are most reflective of cure rate, it also helps to define how the measure is used. For example, the plot of the best-fit line in FIG. 6 can be written in the form: T90=A*(X3Kslope)+B.

Therefore, using the equation for this best fit line, to decide on a proper cure time for each cure, one can measure the term (X3Kslope) in the defined measurement window, and then the measured value can be inserted into the equation above with the coefficients A and B. The resultant time output is the proper cure time as determined by the invention for that cure cycle.

(Step 31) The correlation value can also be improved through the use of multiple regression. Since there are a variety of additional measurements available, a combination of these measurements can often provide a better reflection of cure state when compared to single measurement. The top 20 measurements (i.e. having the highest correlation to T90 measurements) and then reviews all possible 4 term multiple regressions of such 20 measurements, returning the multiple regression equation with the best R-squared correlation in the form of:

T90=A1*Z1+A2*Z2+A3*Z3+A4*Z4+B (Equation 1)

where all the A terms and B terms are coefficients, and all the Z terms are some form of impedance property measurement as previously defined. Therefore, the control system need only to make the 4 measurements and insert them into the equation in order to calculate the proper cure time.

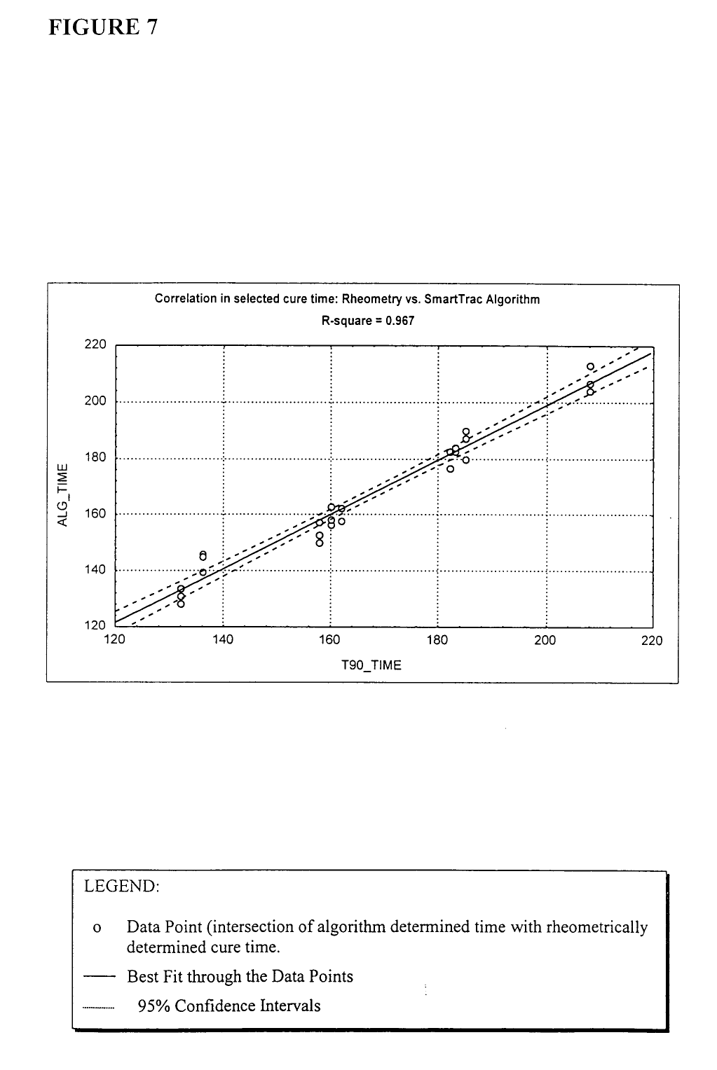

FIG. 7 shows a plot of the resultant algorithm selected cure times versus the T90 times, using a four-term multiple regression. Note the improvement in R-square from 0.889 (FIG. 6) to 0.967 (FIG. 7).

(Step 32) At this point the cure control Equation 1 is defined, with the exception that the equation is truly only responsive to changes in the process that effect cure rate, and it does not necessarily provide the specific cure state desired. This is due to the fact that the rheometric T90 times used in the correlation are only relative and may not provide the specific property desired in the production-molded product. In order to adjust the cure control equation to provide the true optimum cure time, it also has a linear adjustment (known as “the modifier”) that will allow it to operate at some multiple of its standard output. The “modifier” is factored into the cure control equation as follows:

T90[optimized]=(modifier)*(A1*Z1+A2*Z2+A3*Z3+A4*Z4+B) (Equation 2)

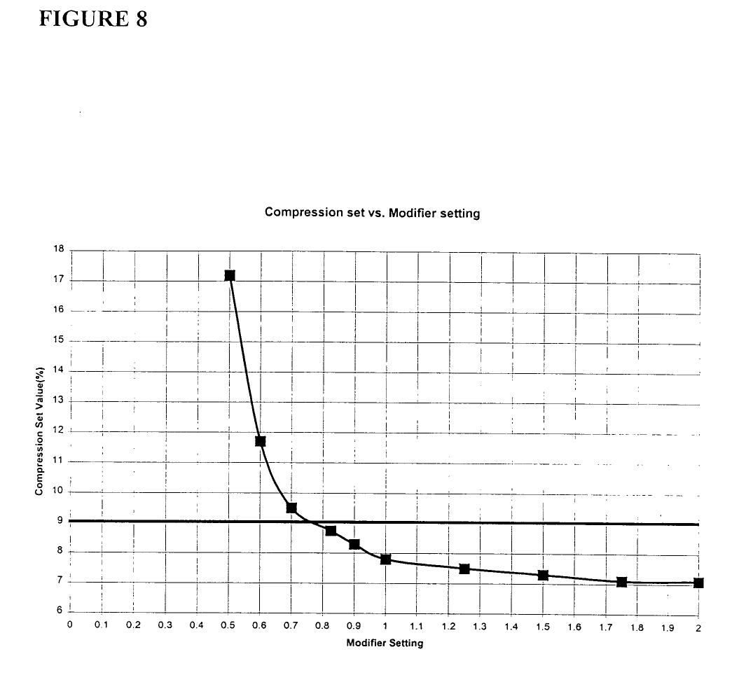

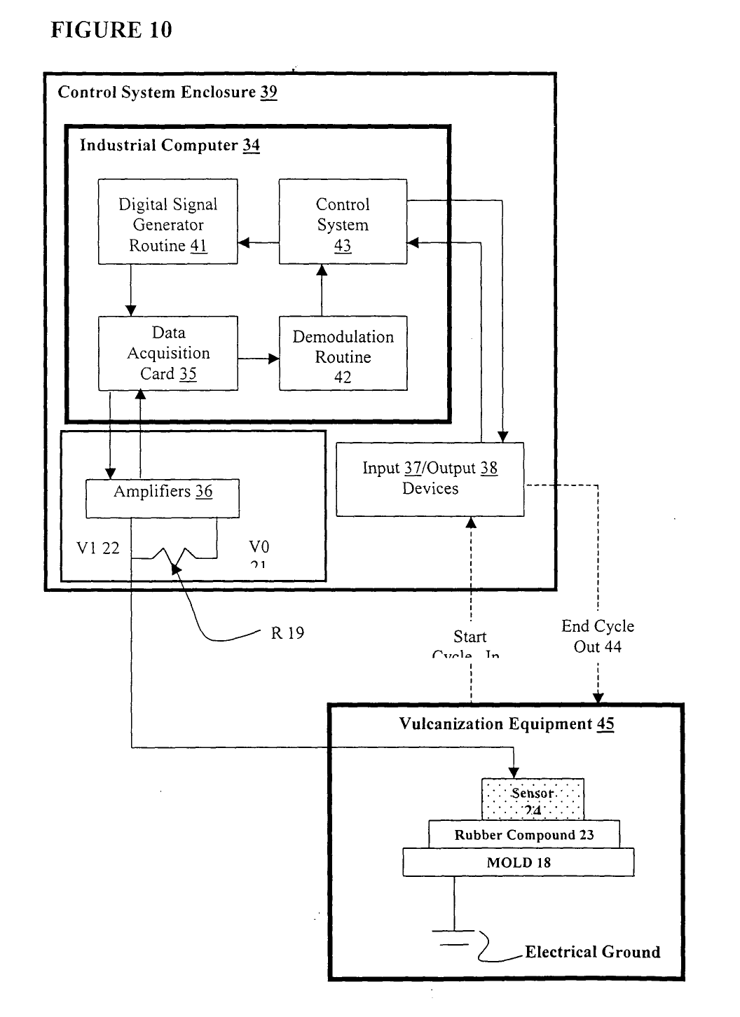

a. In order to determine an appropriate modifier setting, the vulcanization equipment 45 is run with the control system (FIG. 10) controlling the cure time. The modifier setting in equation 2 is changed over a relatively large range, in several increments, and the resultant part properties are measured. In this way, a plot of part property (i.e. spring constant, compression set, dynamic stiffness, etc) versus. modifier setting can be developed. Multiple parts should be produced for each modifier setting to get a good representative property. An example plot is shown in FIG. 8.

Note that it may be desirable to consistently have compression set values of less than a certain amount (9%, for example). Given that specification, it is clear that a modifier of at least 0.8 would be required, and to include some safety factor, 0.9 may be more appropriate. Any higher modifier setting will simply extend cure time without improving compression set. Any lower modifier setting will not provide the specified compression set value.

(Step 32) After choosing the appropriate modifier the control algorithm 43 is ready to be used to control the rubber curing process.

(2.4.2) Embodiment Foralgorithm Development Using a Rheometer Only:

In an alternate embodiment of the invention, a production press need not be used for the initial stages for determining Equation 2. Instead, a sensor can be installed directly into the rheometer, and the impedance data and rheometry can be collected simultaneously. A production press is still required to set the modifier, as described in Step 32 of section (2.4.1).

(2.5) Real-Time Control Application

The control system and its relationship to the vulcanization equipment 45 is shown in FIG. 10. The control unit is equipped with:

(1) An industrial computer 34, for processing data as described above.

(2) A control algorithm 43.

(3) A data acquisition card 35, installed in the computer, for

i. Generating sinusoidal excitation voltages.

ii. Reading and digitizing amplifier outputs.

(4) A digital signal generator software routine 41.

(5) A digital signal demodulation software routine 42 for demodulating signals received from the sensor 17 and the amplifiers 36

(6) Amplifiers 36 for Collection of Real-Time Impedance Data.

(7) Digital inputs 37 for receiving indications of when a cycle has started, or rubber compound injected, or other key discrete data.

(8) Digital outputs 38 for notifying operators of end-of-cure, or energizing relays that open the press, or providing other key discrete outputs.

(9) An enclosure 39 to protect and isolate the components.

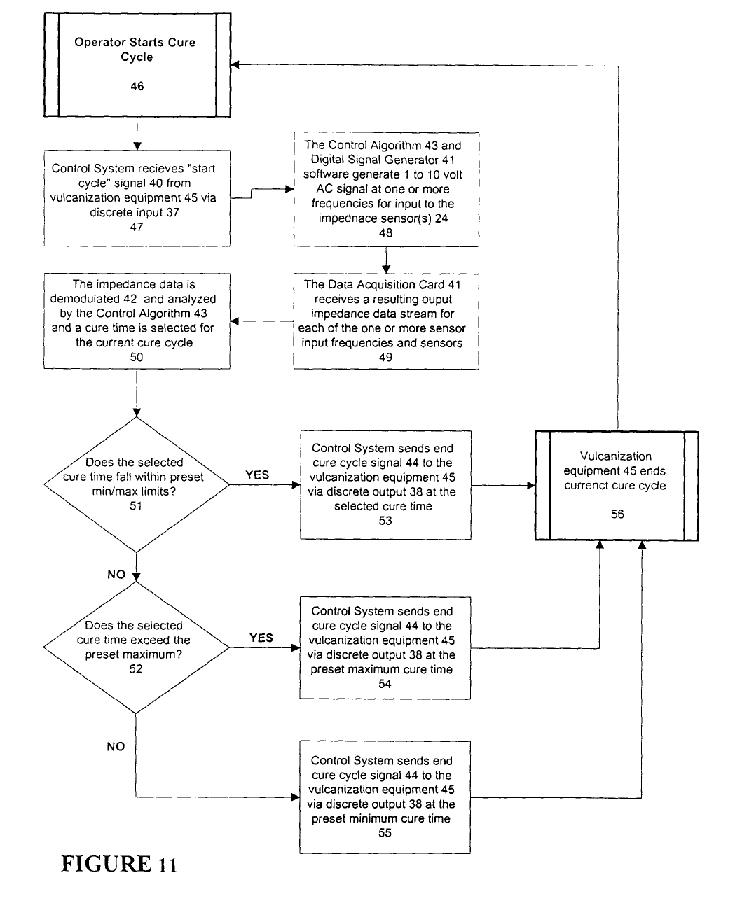

The actual control of the vulcanization equipment 45 is a relatively straight-forward process as shown in FIG. 11. The process can be summarized as follows:

(Steps 46 & 47) When the equipment operator starts a new production cycle 46, a digital input 37 is energized by input 40 from the vulcanization equipment 45 that tells the control algorithm 43 that the cycle has started.

(Step 48) The digital signal generator routine 41 and the data acquisition card 35 then generates digital sinusoidal excitations for one or more sensors 17, as defined by the control algorithm 43 (for example, 1 kHz, 5 kHz, 7 kHz and 9 kHz could be the required frequencies as specified by section 2.4 Methodology for establishing control algorithms.

(Step 49) The data acquisition card 35 and demodulation routine 42 then reads the sensor(s) 17 response.

(Step 50) The demodulated sensor response is recorded by the computer 34 in pairs of impedance data (e.g. Z and Φ, R and X, or G and C). The data is then segmented and measured as required by the control algorithm 43 defined in section 2.4. Those measurements are then used by the control algorithm 43 to calculate a cure time using equation 2.

(Steps 51,53 &56) If the calculated cure time falls within the user set minimum and maximum cure times, a discrete output 38 is energized as output 44 to open the vulcanization equipment 45 at the calculated cure time.

(Steps 51, 52, 54 & 56) If the calculated cure time is greater than the user set maximum cure time, a discrete output 38 is energized as output 44 to open the vulcanization equipment 45 at the maximum cure time.

(Steps 51, 52, 55 & 56) If the calculated cure time is less than the user set minimum cure time, a discrete output 38 is energized as output 44 to open the vulcanization equipment 45 at the minimum cure time.

What is claimed is:

1. A process for curing a natural or synthetic rubber with fillers using a variety of vulcanization equipment, comprising:
a) measuring curing conditions by dielectric or impedance means applied on opposite sides and through the rubber part or a witness cavity representing the part during the curing process to produce a process curve for a specific rubber compound which is correlated with the rheometric properties of the rubber compound and the desired or specified mechanical properties of the rubber part;
b) analyzing the process curve for the specific rubber compound with a software algorithm which defines and quantifies the correlation relationship between the process curve and the rheometric properties of the rubber compound and the desired part mechanical properties;
c) applying the correlation relationship in real-time to end the curing process and produce rubber part(s) of uniform quality and with reduced process cycle time.

2. The process of claim 1, in which the dielectric or impedance measurement circuit is non-bridged.

3. The process of claim 1, in which the correlation is accomplished using a defined range of cure conditions or statistically designed experiment.

4. The process of claim 1, in which the correlation is accomplished using an impedance sensor installed in ODR, MDR, or similar rheometric instrument.

5. The process of claim 1, in which the said software algorithm identifies and uses a Maximum Value, and/or Time of Maximum Value in a specific time segment of the process curve to calculate the end of cure time.

6. The process of claim 1, in which the said software algorithm identifies and uses a Minimum Value, and/or Time of Minimum Value in a specific time segment of the process curve to calculate the end of cure time.

7. The process of claim 1, in which the said algorithm uses the rate of a cure as measured by a linear least-squares best fit over a specified time segment of the process curve and the slope of the segment measured is defined as m in the equation:
y=mx+b.

8. The process of claim 1, in which the said algorithm uses the rate of a cure as measured by an exponential best fit over a specified time segment of the process curve and the damping coefficient of the segment measured is defined as α in the equation:
y=Ae^{-α}

9. The process of claim 1, in which the said algorithm uses the rate of a cure as measured by an exponential best fit over a specified time segment of the process curve and the amplitude coefficient of the segment measured is defined as A in the equation:
y=Ae^{-αx}

10. The process of claim 1, in which the said algorithm uses the integrated area under the process curve or a portion of the curve to calculate the end of cure time.

11. The process of claim 1, in which the dielectric or impedance measurements include impedance (Z), phase angle (Φ), resistance (R), reactance (X), conductance (G) and capacitance (C) as values for the y-axis of the process curve as plotted against time on the x-axis.

12. The process of claim 1, in which the correlation is made between mathematical measurements of the process curve and rheometric property measurements of the rubber compound and to the desired or specified part mechanical properties such as tensile strength, compression set, dynamic stiffness, or elastic torque.

13. The process of claim 12, in which the final correlation to the part mechanical properties is made with a modifier which provides a linear adjustment to the T90, T75, T50, T2 or rheometric correlation equation.

14. The process of claim 1, in which the impedance measurements are made at a frequency of about 10 Hz to 200,000 Hz.

15. The process of claim 1, in which said natural and synthetic rubber compounds are typically selected from the group consisting of: styrene-butadiene, polybutadiene, polyisoprene, ethylene-propylene, butyl, halobutyl, ntirile, polyacrylic, neoprene, hypalon, silicone, fluorcarbon elastomers, polyurethane elastomers, and mixtures thereof.

16. The process of claim 15, in which rubber compound fillers consist of: carbon black, clays, oils, silicas, and the like.

17. The process of claim 1, in which the said process is controlled by means of a computer.

18. The process of claim 17, in which said computer controls the process by receiving a “start cure” signal from the vulcanization equipment and based on a predefined software algorithm sends an “end cure” signal back to the vulcanization equipment.

19. The process of claim 1, in which the rubber part is processed using vulcanization equipment and its associated tooling and the impedance measuring means includes the vulcanization equipment and/or its associated tooling.

20. The process of claim 19, in which the impedance measuring means includes a primary sensor electrode coupled with an opposing grounded surface electrode, which is part of the vulcanization equipment or associated tooling.

21. The process of claim 19, in which the impedance sensor is located either in contact with the part or in contact with a rubber filled witness cavity that is representative of the part.

22. The process of claim 19, in which the impedance sensor includes an additional guard electrode to help preclude the primary electrode from fringing or becoming non-linear.

23. The process of claim 19, in which the impedance sensor primary and guard electrodes are separated from the rubber compound being processed by alumina ceramic or other stable and abrasion resistant dielectric material.

24. The process of claim 19, in which the impedance sensor primary electrode, guard electrode, and housing are separated electrically from each other by a dielectrically stable polymer such as cyanate ester and alumina ceramic.

25. The process of claim 19, in which the impedance sensor primary electrode, guard electrode, and housing are fused together and separated electrically from each other by glass or glass doped with alumina ceramic or other like material.

26. The process of claim 19, in which the primary electrode and guard electrode are embedded in a metallized and layered ceramic circuit.

27. The process of claim 19, in which the primary electrode, guard electrode, and housing are press fit together and separated electrically from each other and the rubber compound being cured by a diamond or diamond like coating.

28. The process of claim 18, in which said vulcanizing equipment includes: injection molding machines, compression and transfer molding presses, belt making presses, autoclaves, tire molding machines, and the like.

29. The process of claim 19, in which said tooling includes: injection molds, compression and transfer molds, mandrels, platens, tire molds, and the like.

30. The process of claim 18, in which said control is accomplished using more than one sensor to monitor the process, and the lagging sensor from cycle-to-cycle is used to control the end point of any given cure cycle.
